(19) United States
(12) Patent Application Publication
(10) Pub. No.: US 2026/0326207 A1
(43) Pub. Date: Oct. 22, 2026

(54) LAMINAR FLOW LOCALIZED PROTECTIVE ATMOSPHERE FOR ADDITIVE CASTING

(71) Applicant: Magnus Metal Ltd., Revadim (IL)

(72) Inventors: Ofer TEVET, Herzelia (IL); Jesús Sánchez LACASA, Tel Aviv (IL); Tomer AVRAMOVITCH, Rehovot (IL)

(21) Appl. No.: 19/108,756

(22) PCT Filed: Sep. 5, 2023
(86) PCT No.: PCT/IL2023/050953

§ 371 Date: Mar. 5, 2025

Related U.S. Application Data
(60) Provisional application No. 63/374,616, filed on Sep. 6, 2022.

(51) Int. Cl. B22F 12/70; B22F 10/32; B22F 12/20; B33Y 10/00; B33Y 30/00; B33Y 40/00

(52) U.S. Cl. CPC B22F 12/70; B22F 10/32; B22F 12/20; B33Y 10/00; B33Y 30/00; B33Y 40/00

(57) ABSTRACT

A protective device for protecting a metal source, the protective device may include multiple gas channels, one or more inlets configured to receive an inert gas, and one or more distribution elements configured to receive the inert gas from the one or more inlets and to evenly distribute the inert gas between the multiple gas channels. The multiple gas channels are configured to output the inert gas in multiple directions, wherein a first plurality of directions of the multiple directions differs from each other by an azimuthal angle.

### CROSS REFERENCE

This application claims priority from U.S. provisional patent filing date Sep. 6, 2022, Ser. No. 63/374,616, which is incorporated by reference in its entirety.

### TECHNICAL FIELD OF THE INVENTION

The application generally relates to the field of additive manufacturing under a protective atmosphere. More specifically, the application relates to the field of localized protective atmosphere for additive manufacturing or additive casting of parts.

### BACKGROUND OF THE INVENTION

Additive casting is branch in additive manufacturing (Three-Dimensional (3D) printing) which replacing traditional casting. There is a growing need for a localized protective atmosphere of metal rods, wires, crucibles, and the like used for additive manufacturing and especially for additive casting of metal and metallic objects.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an example of a radial laminar flow localized protective atmosphere device according to embodiments of the invention, together with a metal source and a heating element;

FIGS. 2A-2C illustrate additional aspects of laminar flow localized protective atmosphere devices according to embodiments of the invention;

FIGS. 3A-3D are cross-sectional and isometric views of a radial laminar flow localized protective atmosphere device according to an embodiment of the invention;

FIG. 4 illustrates the laminar flow localized protective atmosphere device of FIGS. 3A-3D together with a metal source and a heating device according to an embodiment of the invention;

FIGS. 5A-5B and 6 illustrate additional aspects of laminar flow localized protective atmosphere devices according to embodiments of the invention;

FIGS. 7-10 illustrate additional aspects of laminar flow localized protective atmosphere devices according to embodiments of the invention;

FIGS. 11-12 are schematic illustrations of examples of laminar flow localized protective atmosphere devices according to embodiments of the invention;

FIG. 13 illustrates a flow of inert gas and Oxygen concentration in the vicinity of a protective device according to an embodiment of the invention; and

FIG. 14 illustrates an example of a method according to an embodiment of the invention.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numerals may be repeated among the Figures to indicate corresponding or analogous elements.

Any reference in the specification to a system should be applied mutatis mutandis to a method that may be executed by the system and should be applied mutatis mutandis to a non-transitory computer readable medium that stores instructions that may be executed by a controller of the system.

According to embodiments of the invention, there is provided a laminar flow localized protective atmosphere device. The laminar flow localized protective atmosphere device will be described with reference to its use in systems for digitally planned and controlled additive metal casting. Examples of digitally planned and controlled additive metal casting systems are described, for example, in U.S. patent application publications serial numbers 20200206810, 20230021374, and 20220371086 by the same applicant of this application, which are incorporated herein by reference. The invention is not limited to such use and is applicable to any other system requiring a localized protective atmosphere.

Aspects of laminar flow localized protective atmosphere are described in (1) J. Ding, P. Colegrove, F. Martina, S. Williams, R. Wiktorowicz, M. R. Palt, Development of a laminar flow local shielding device for wire+arc additive manufacture, Journal of Materials Processing Technology, Volume 226, 2015, Pages 99-105, ISSN 0924-0136, https://doi.org/10.1016/j.jmatprotec.2015.07.005 (Ding); (2) T. P. Chong, P. F. Joseph, P. O. A. L. Davies, Design and performance of an open jet wind tunnel for aero-acoustic measurement, Applied Acoustics, Volume 70, Issue 4, 2009, Pages 605-614, ISSN 0003-682X, https://doi.org/10.1016/j.apacoust.2008.06.011. (Chong); (3) Vinayak Kulkarni, Niranjan Sahoo, Sandip D. Chavan, Simulation of honeycomb—screen combinations for turbulence management in a subsonic wind tunnel, Journal of Wind Engineering and Industrial Aerodynamics, Volume 99, Issue 1, 2011, Pages 37-45, ISSN 0167-6105, https://doi.org/10.1016/j.jweia.2010.10.006. (Kulkarni) and (4) U.S. Pat. No. 10,451,542—which are incorporated herein by reference.

The laminar flow localized protective atmosphere device will be described herein with reference to shielding a metal rod that is used as a metal source in systems for digitally planned and controlled additive metal casting. The laminar flow localized protective atmosphere device according to embodiments of the invention, may provide a protective atmosphere to the metal rod and especially to areas of the metal rod that are heated during additive casting—the tip of the rod and the shoulder area of the rod. In such systems, areas of the metal rod that are heated during additive casting—the tip of the rod and the shoulder area of the rod—are placed above the heating device (e.g., an induction heater). According to embodiments of the invention, the tip of the rod and/or the shoulder area of the rod—which are concealed from the protective device—are adequately shielded.

According to an aspect of the invention, there is provided a laminar flow localized protective atmosphere device for shielding a metal source, the device comprises: one or more distribution elements, each distribution element comprising one or more distribution (diffusion) chambers having one or more gas inlets for receiving an inert gas, one or more porous material (e.g., ceramic foam) layer located downstream of the one or more diffusion chamber, and a radial gas distribution array located downstream of the ceramic foam layer, wherein the radial gas distribution array comprises a plurality of gas channels (output channels) which are radially inclined with respect to the metal source. According to another aspect of the invention, the distribution element includes one or more barrier channels. In some embodiments, no porous material layer is used. Compared to prior art systems, the use of a setting chamber and metal mesh downstream of the radial gas distribution array is obviated.

According to an embodiment, there is provided a protective device for protecting a metal source, the protective device includes (a) one or more distribution inlets configured to receive an inert gas through one or more inlets; (b) one or more distribution elements; and (c) multiple gas channels (output channels) configured to output the inert gas.

The one or more distribution elements are configured to evenly distribute the inert gas between the multiple gas channels.

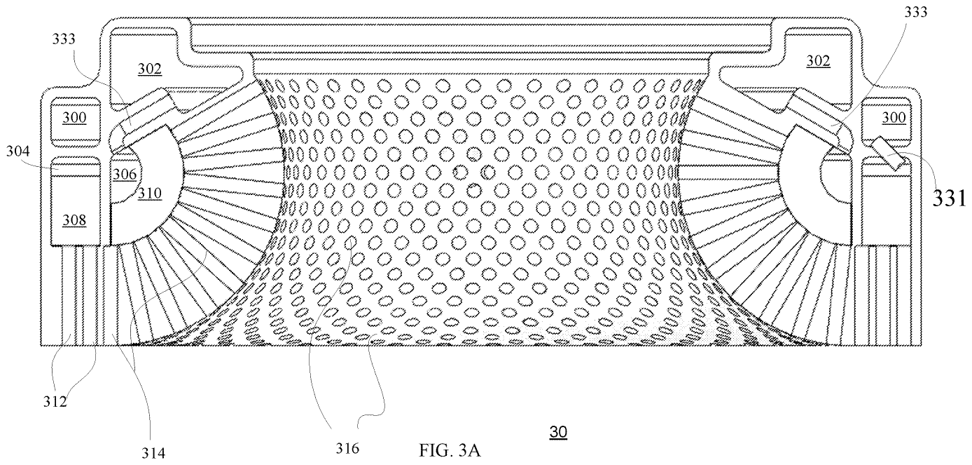

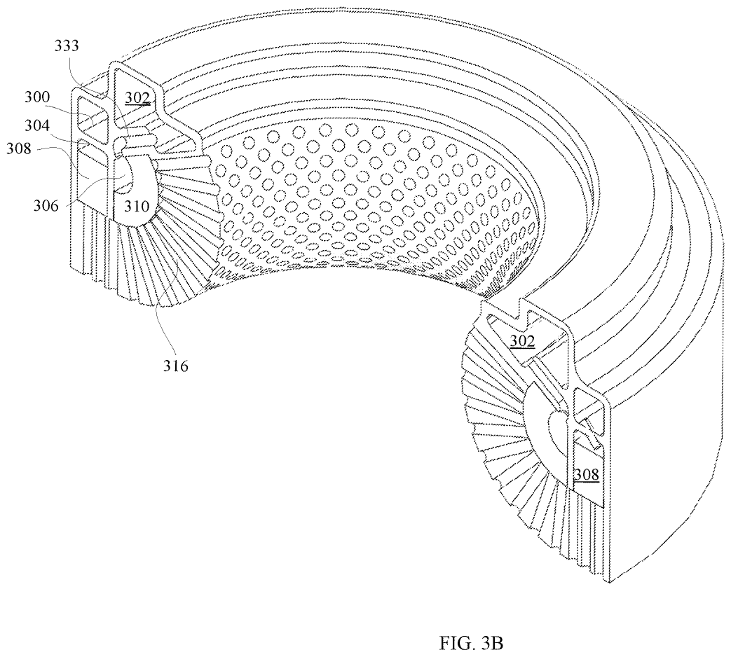

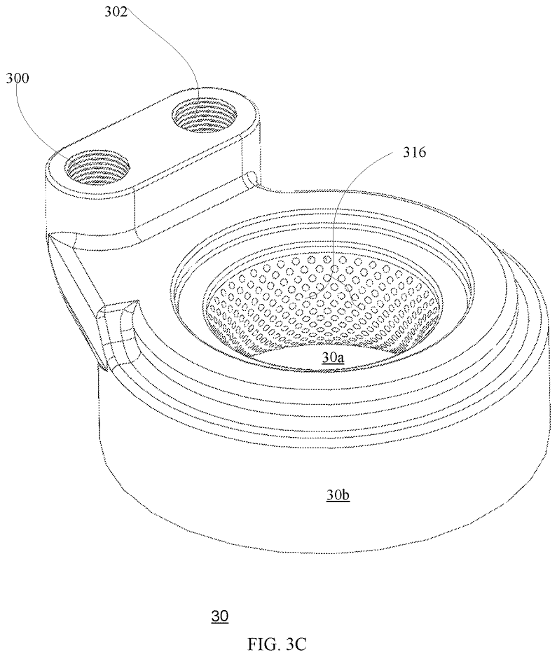

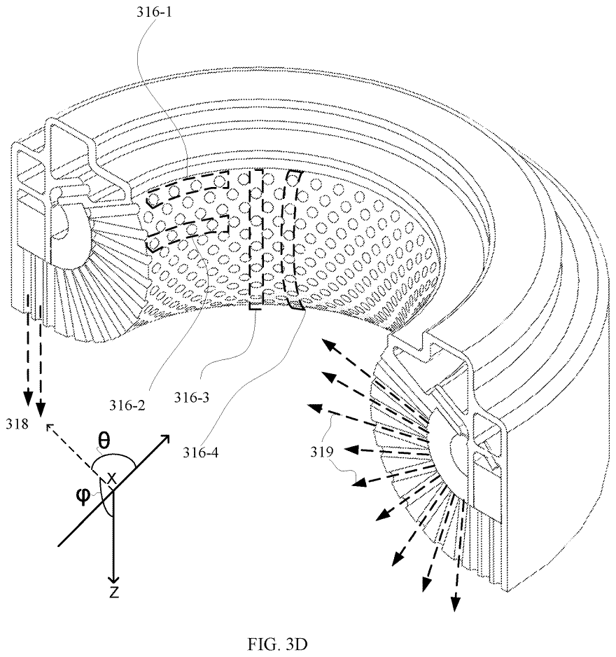

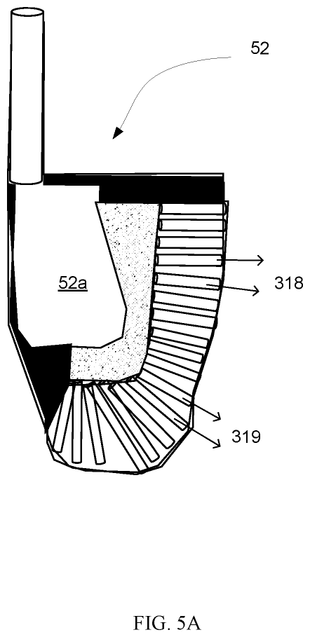

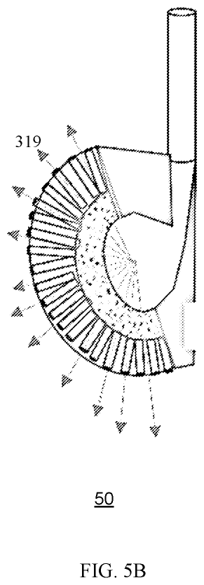

The multiple gas channels are configured to output the inert gas at multiple directions, wherein a first plurality of directions of the multiple directions differs from each other by an azimuthal angle. Various directions are denoted 318 and 319 in FIG. 3D and denoted 319 in FIG. 5B.

In FIGS. 3A, 3B, 3C and 3D the multiple directions illustrate a radially distributed azimuthal angles. Radially distributed azimuthal angles are defined by gas distribution directions that intersect at a single point (such as radiuses of a virtual circle).

It should be noted that non-radially distributed azimuthal angles may be provided (see, for example FIGS. 5A and 5B). Non-radially distributed azimuthal angles are defined by gas distribution directions that intersect at multiple points (not like radiuses of a virtual circle).

According to an embodiment, the multiple gas channels are configured to output the inert gas in multiple directions while maintaining a laminar flow at least in proximity to the protective device. The laminar flow zone is proportional to the diameter of the output channels. For example, for output channels with a diameter in the range of 1-6 mm, the laminar flow zone may be in the range of 1-20 mm from the protective device.

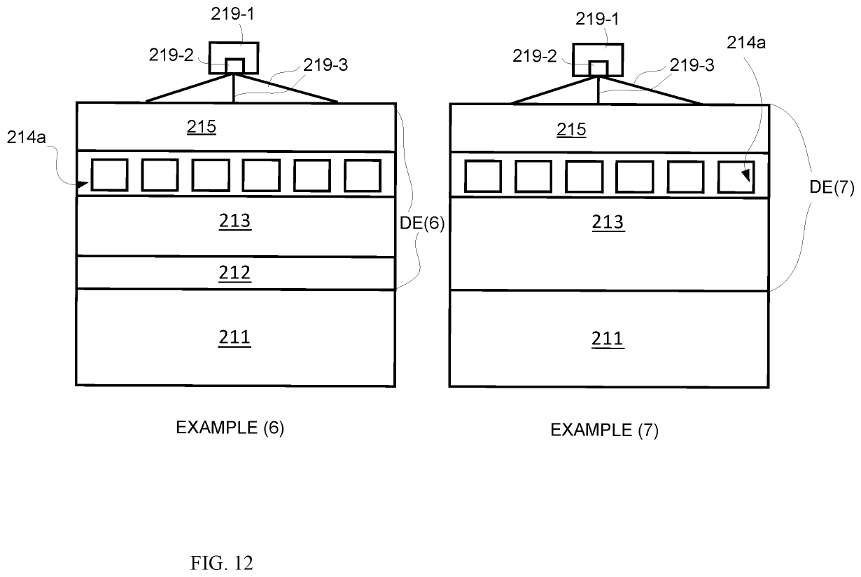

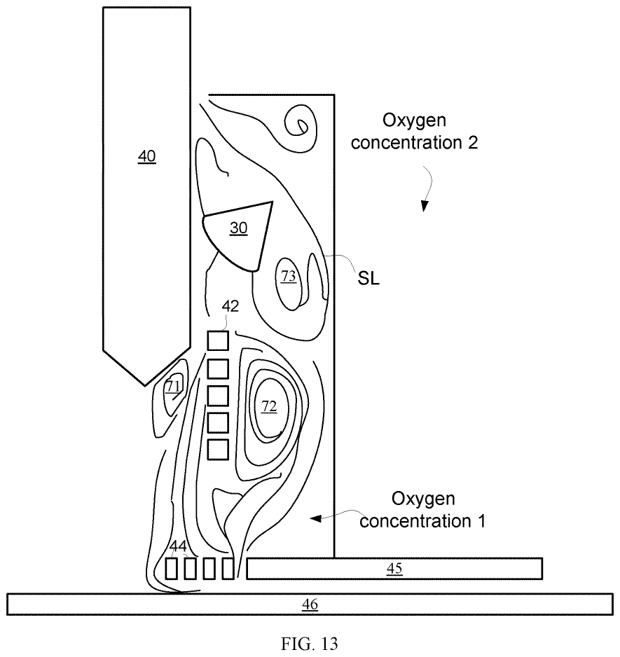

According to an embodiment of the invention, one or more distribution elements include one or more distribution chambers (some of which are also referred to as diffusion chambers) for restricting the airflow of the inert gas between one or more distribution inlets and the multiple gas channels. Non-limiting examples of the one or more distribution chambers include diffusion chamber 304 of FIG. 3A, diffusion chamber 306 of FIG. 3A, distribution chamber 218 of FIG. 12, first distribution chamber 215 of FIGS. 12 and 13, and second distribution chamber 213 of FIGS. 12 and 13. The term “diffusion” is an example of a distribution of the inert gas—especially a distribution of the inert gas through small, restrictive structures such as the pores of a porous material or the small diameter of the barrier channels.

According to an embodiment of the invention, the one or more distribution chambers include one or more first distribution chambers and one or more second distribution chambers that are downstream of the first distribution chambers. Non-limiting examples include the first distribution chamber 215 of FIGS. 12 and 13, and the second distribution chamber 213 of FIGS. 12 and 13.

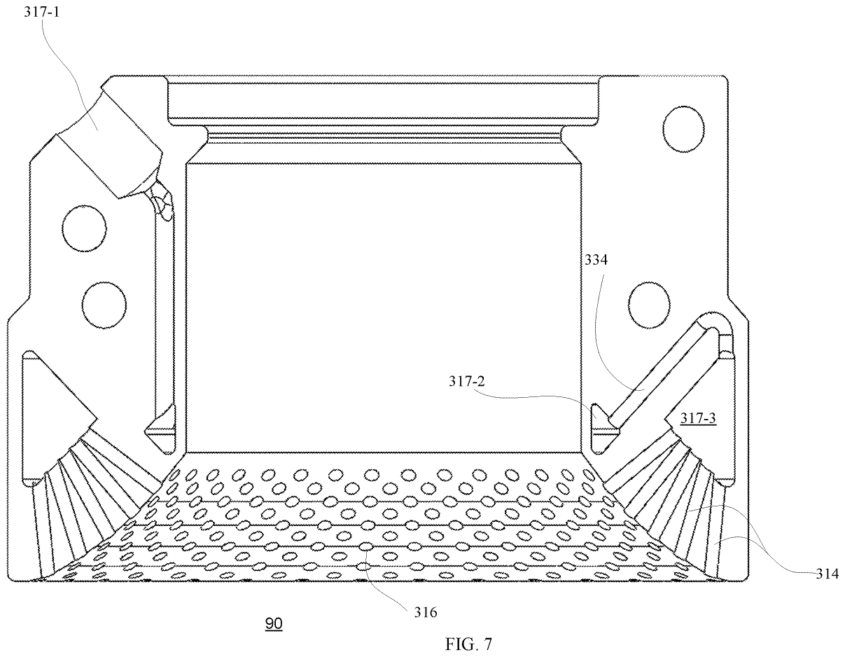

According to an embodiment, the device further includes barrier channels for fluidly coupling the one or more first distribution chambers to the one or more second distribution chambers. Non-limiting examples of such barrier channels are barrier channels 333, 331 of FIG. 3A, barrier channel 334 of FIG. 7 and barrier channels 214a and 214b of FIG. 12.

According to an embodiment of the invention, the barrier channels have a top-down orientation: the barrier channel input is higher than the barrier channel output. A non limiting example of the top-down orientation is barrier channel 333 of FIG. 3A. According to another embodiment, the barrier channels have a bottom-up orientation, for example, barrier chamber 334 of FIG. 7, having a barrier channel input that is lower than the barrier channel output. The orientation of the barrier channels impacts the resistivity of the barrier channels to the airflow. Further, the diameter of the barrier channels may be selected to further restrict the flow of air through the barrier channels.

According to an embodiment the one or more distribution elements include one or more porous material elements. Non-limiting examples one or more distribution elements include one or more porous material elements include foam layer 308 and foam layer 310 in FIG. 3A and porous material elements 212 of FIGS. 12 and 13. According to an embodiment the porous material elements metal foam or ceramic foam or steel wool or ceramic wool.

According to an embodiment the one or more porous material elements have non-homogeneous pore density.

According to an embodiment the one or more distribution chambers are located upstream of the one or more porous material elements. See, for example, diffusion chamber 304 and diffusion chamber 306 that are located upstream of foam layer 308 and foam layer 310 in FIG. 3A.

According to an embodiment the one or more gas channels are cavities that are formed in a bulk. See, for example, gas channels 316 of FIG. 3A.

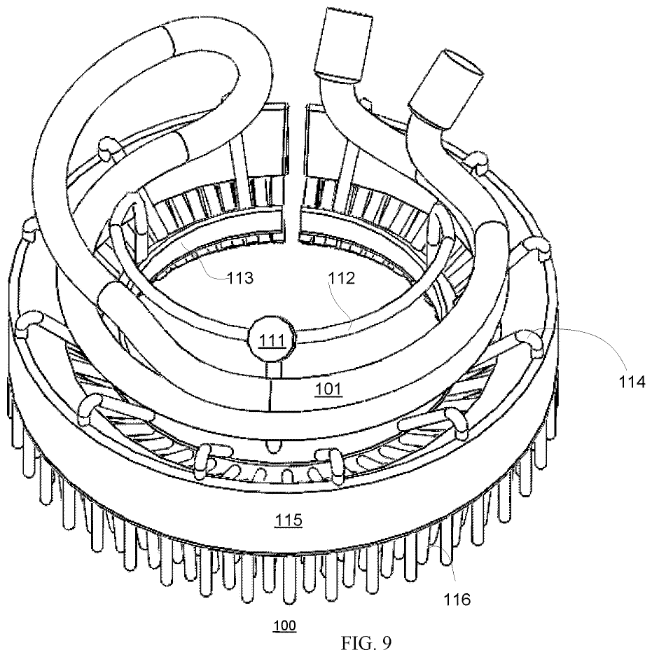

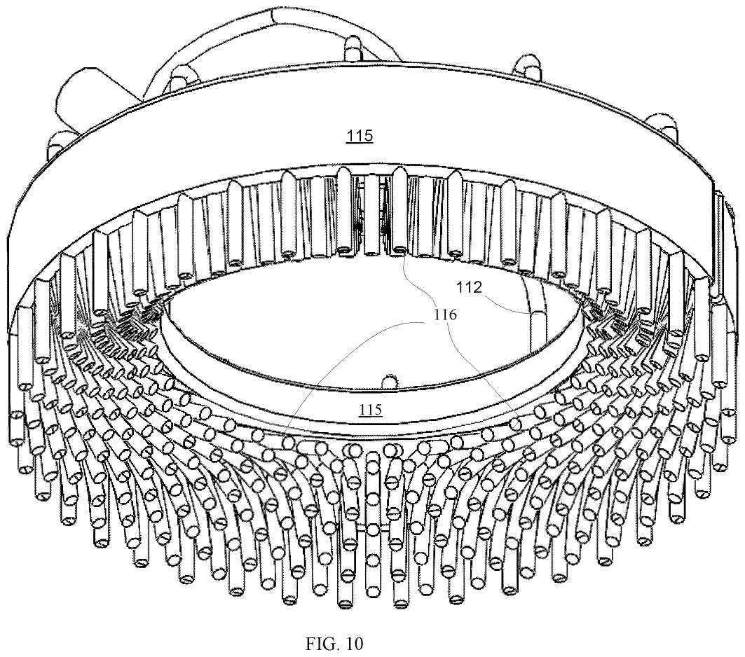

According to an embodiment the one or more gas channels are spaced apart pipes having gaps therebetween. See, for example, gas output channels 116 of FIGS. 9-11.

According to an embodiment, a second plurality of directions of the multiple directions differs from each other by a polar angle. See, for example, gas channels 316-1 shown in FIG. 3D that are of the same azimuthal angles but are positioned at different polar angles.

According to an embodiment, a third plurality of directions of the multiple directions share the same azimuthal angle. See, for example, gas channels 316-2 channels that are of the same azimuthal angles.

According to an embodiment, a fourth plurality of directions of multiple directions share a same polar angle. See, for example, gas channels 316-3 that have the same polar angle. See, also, for example, gas channels 316-4 that have the same polar angle.

According to an embodiment, a direction in which a gas is outputted from a gas channel is parallel to the longitudinal axis of the gas channel. In FIG. 3D the gas channels are arranged in staggered rings. Gas channels of the same ring share the same azimuthal angle o but differ from each other by their polar angle θ. Gas channel openings of different rings may share the same polar angle while they differ from each other by their azimuthal angle.

It should be noted that some gas channels may differ from each other by their azimuthal angles and by their polar angles.

According to an embodiment, the protective device includes one or more liquid cooling paths.

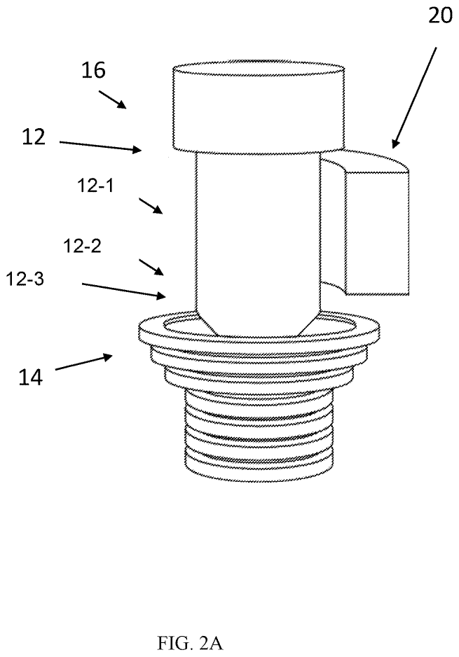

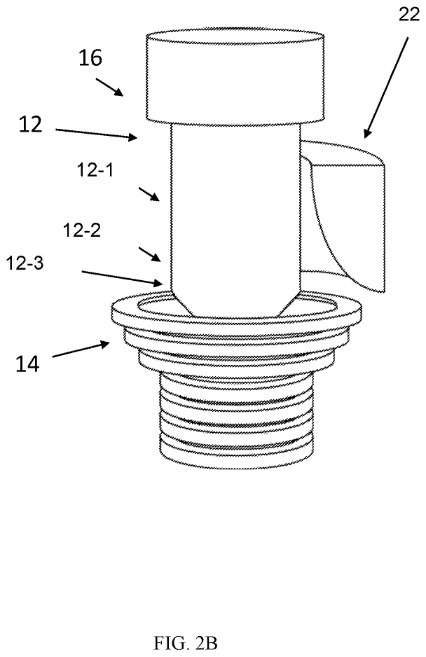

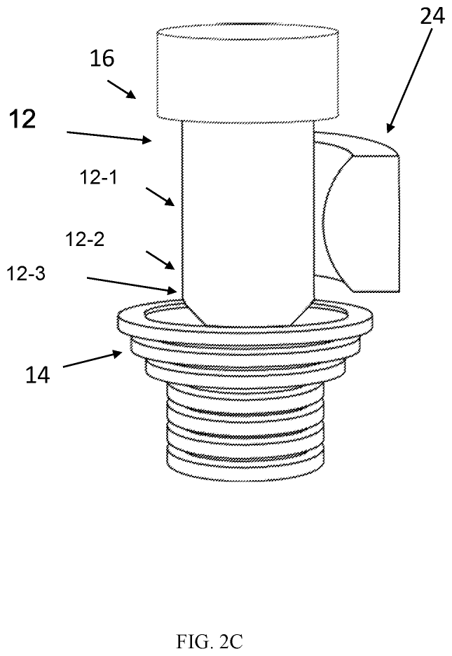

According to an embodiment, the protective device is shaped and positioned to at least partially surround the metal source. See, for example, FIGS. 2A, 2B and 2C, which illustrate the cooling sleeve that surrounds the middle of the metal source.

In some additive casting scenarios, portions of the metal source) are concealed from at least one of the multiple gas channels. For example, in some additive casting scenarios employing a metal rod, the rod's shoulder area and/or rod's tip are concealed from at least one of the multiple gas channels. See, for example, FIGS. 2A, 2B and 2C, which illustrate that the tip is concealed from the main body of the protective device. In the presence of heating device (heater) 14, straight output gas channels cannot reach the full length of the rod, the tip of the rod and the shoulder areas. Thus, a flow of inert gas perpendicular to the main body of the protective device, as in prior art systems, will not protect the rod's tip and shoulder areas. In some embodiments of the invention, the protective device is configured to direct inert gas to the area of the metal source that is concealed from at least one of the multiple gas channels.

According to an embodiment of the invention, the one or more inlets include a primary inlet, wherein the primary inlet is upstream of a splitter that is upstream of two or more secondary inlets.

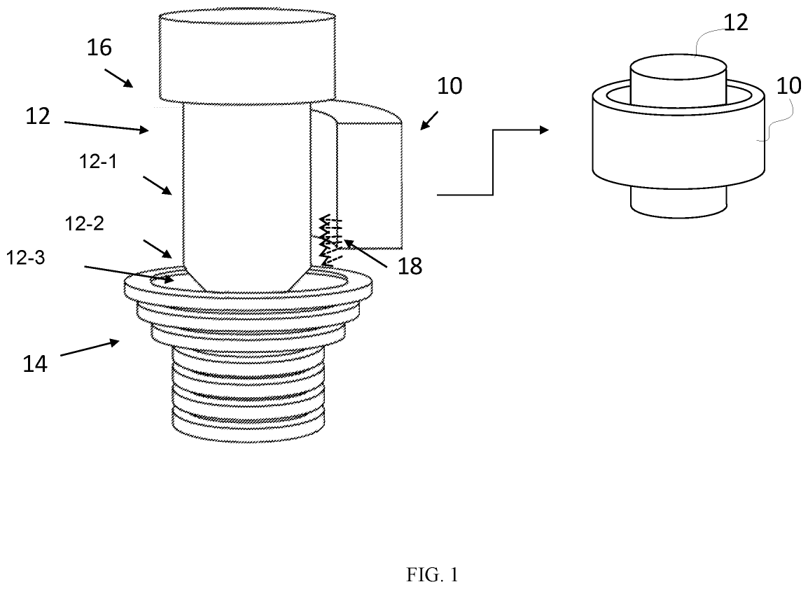

FIG. 1 schematically illustrates a radial laminar flow localized protective atmosphere device 10 according to embodiments of the invention. The radial laminar flow localized protective atmosphere device 10 may have a circular shape and envelop a rod 12. Rod 12 may be held by a rod holder (not shown). Rod 12 may be enveloped at its higher end (the end far away from the heater 14) by a cooling sleeve 16. During additive metal casting, rod 12 may be lowered toward the area to be cast (not shown) and be heated by heater 14. In some embodiments, heater 14 may be realized as an induction heater. During additive metal casting, heater 14 may heat rod 12 up to melting temperature (for example, 1150 Celsius degrees for gray iron) and beyond. In response, rod 12 is accumulating heat at its tip 12-3 (below the shoulder 12-2) as well as in the rod's middle part 12-1, above the shoulder.

Heater 14 is illustrated as a 7-turn coil. The invention is not limited by the type and shape of the coil and by the coil's number of turns.

In some additive metal casting scenarios, the tip of rod 12 is placed adjacent to or within a space defined by one or more of coil turns of heater 14. For various additive casting applications, shielding the tip area and/or shoulder area of rod 12 is required.

As will be discussed later with reference to FIGS. 3A-3D, the radial laminar flow localized protective atmosphere device according to embodiments of the invention, may comprise one, two, or more sections. Each section has one or more distribution (diffusion) chambers which have one or more gas inlets for receiving an inert gas, one or more porous material (e.g., ceramic foam) layers located downstream toward one or more radial gas distribution arrays, wherein the radial gas distribution array comprises a plurality of gas channels which are radially inclined with respect to the metal source axis.

The radial inclination of the gas channels may not be identical. For various applications, localized protective atmosphere 18 (schematically illustrated as gas lines 18) in FIG. 1, according to embodiments of the invention, is provided in the tip area of the rod, the shoulder area and at part or all of the rod's middle part.

FIGS. 2A-2B illustrate additional aspects of laminar flow localized protective atmosphere devices 20, 22, 24 with radially-inclined gas channels (not shown) according to embodiments of the invention. Device 20 has a square-shaped cross-section. Device 22 differs from device 20 by having a curved cross-section. Device 22 may direct larger flows of inert gas toward the tip of rod 12 compared to device 20. Device 24 has a double-curve shape (a symmetrical double-curve shape is shown, but this is not necessarily so). Device 24 may direct larger flows of inert gas toward the middle part of rod 12 compared to device 20.

FIGS. 3A-3D are cross-sectional and isometric views of a radial laminar flow localized protective atmosphere device according to an embodiment of the invention.

FIGS. 3A-3B illustrate, in a non-limiting manner, a radial laminar flow localized protective atmosphere device 30 having two sections: two diffusion chambers 304 and 306, having inlet 300 and inlet 302 for receiving an inert gas from an inert gas supply (not shown) through top-down barrier channels 331 and 333, and for uniformly distribute the inlet gas.

Downstream of the metal source (rod 12 shown in FIG. 1), each of diffusion chambers 304 and 306 is followed by a foam layer 308, 310, respectively, through which the gas is distributed.

Thus, the first section comprises diffusion chambers 304 having inlet 300, barrier channel 331, foam layer 308, and gas distribution array 312; and the second section comprises diffusion chambers 306 having inlet 302, barrier channel 333, foam layer 310, and gas distribution array 314 that includes gas channels 316.

Foam layers 308, 310 may be made of a ceramic material. For the additive casting of gray iron, as an example, foam layers 308, 310 may be made of a refractory ceramic material that can withstand higher temperatures (e.g., 1150 up to 1300 Celsius degrees for gray iron). Metal foam (e.g., made of steel) is another suitable material. The invention is not limited by the type of foam material to be used.

Foam layers 308, 310 may be made from the same porous material; however, this is not necessarily so.

Foam layers 308, 310 may be selected with a variety of pores per inch (PPI). For some applications, 10 PPI, 20 PPI, 30 PPI materials are suitable. For other applications, 40 PPI, 50 PPI, 60 PPI, and 70-70 PPI may be used.

Foam layers 308, 310 may be made with the same pore density (same PPI); however, this is not necessarily so.

Different zones of foam layers 308, 310 may have different pore densities (different PPI).

The thickness of foam layers 308, 310 may be selected according to applicational needs. The thickness of foam layers 308, 310 may be identical; however, this is not necessarily so. The thickness of each foam layer 308, 310 may vary such that different foam layer areas have different thicknesses.

Additional flow-restricting elements that are capable of withstanding high temperatures can be used, for example, ceramic fiber wool blankets, steel wool, iron wool, and the like.

Further downstream of the metal source (rod 12 shown in FIG. 1), each of foam layers 308, 310 is followed by gas distribution arrays 312, 314, respectively, through which the gas is distributed and turbulence flow is reduced. One or both gas distribution arrays 312, 314 may comprise a plurality of gas channels 316, which are radially inclined with respect to the metal source.

Prior-art gas distribution arrays, also known as ‘honeycomb’, are typically characterized by straight gas channel arrangement. Straight gas channel arrangements are described, for example, in U.S. Pat. No. 10,451,542B2 and by Ding, Chong, and Kulkarni, cited above.

The term “radially inclined” as used herein, means that part or all of the gas channels are inclined with respect to an axis defining the metal source. Some of the gas channels are perpendicular (radial) to the rod axis, some of the gas channels are parallel to the rod axis, and some—inclined at various angles between perpendicular position and parallel position. In the setup shown in FIG. 1, implementing prior art laminar flow localized protective atmosphere device that uses a honeycomb of straight gas channels that would be positioned perpendicular to rod 12 axis would not provide the same shielding. According to embodiments of the invention, part or all of the gas channels of the gas distribution array of device 10 give rise to gas lines 18, which are radially inclined, and some may be parallel to the rod 12 axis.

According to embodiments of the invention, various design parameters of the gas channels and the gas distribution arrays are selected. Each gas channel serial no. i, i=1, . . . , N may be characterized by its aperture cross-section shape, aperture cross-section diameter Di, and channel length Li. The length-diameter ratio may follow the relation [1]: Li>=5×Di, i=1, . . . , N.

According to embodiments of the invention, the number N of gas channels in one or more gas distribution arrays is selected in alignment with the geometrical shape of the diffusion chamber, including its inlet and the geometrical shape and material properties of the foam layer so as to secure laminar flow.

In some embodiments, a single diffusion chamber with a respective single foam layer (or concentric multi-layers) and a single gas distribution array with a selected number N of gas channels with a selected cross-section shape, diameter, and length—are suitable for specific requirements.

In some embodiment, addressing other requirements—more than one diffusion chamber is used, each with a respective single foam layer (or concentric multi-layers) and a single gas distribution array with a selected number N of gas channels with a selected cross-section shape, diameter, and length—are used.

In the example of FIG. 3A, the number of gas channels in gas distribution arrays 312, 314 is different; the aperture diameter of all of the gas channels in gas distribution arrays 312, 314—is identical, and the respective lengths are different. Note, however, that this is not necessarily so.

FIG. 3C is an isometric view of the radial laminar flow localized protective atmosphere device 30 of FIGS. 3A-3B. The circular inner shape 30a of device 30 are shown for enveloping a circular metal source such as rod 12 of FIG. 1. The circular outer shape 30b of device 30 is shown.

The invention is not limited by the type of the inner and outer shapes of the radial laminar flow localized protective atmosphere shielding device. For example, any polyhedron shape may be applicably used for the inner and outer shape of the radial laminar flow localized protective atmosphere device. Further, non-symmetrical inner shape (for example, shape 52a, as shown in FIG. 5A) may apply. Further, non-identical inner and our shapes may be used (shape 52a as shown in FIG. 5A).

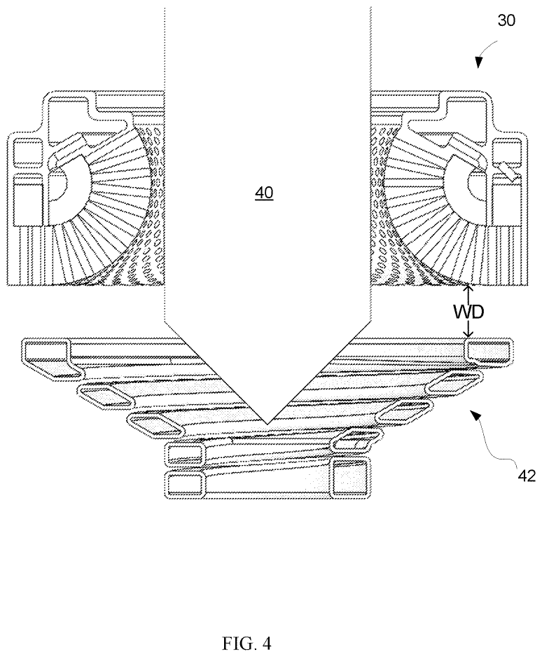

FIG. 4 illustrates the radial laminar flow localized protective atmosphere device 30 of FIGS. 3A-3B in combination with additional elements of an additive casting system: rod 40—metal source—is shown, as well as the heating device 42. During operation, rod 40 may be moved in the Z-direction: rod 40 may be lowered from a no-casting position, well above heating device 42, to a casting-ready position, in proximity to the heating device 42. As the heating device 42 heats and melts the tip of rod 40, the rod is further lowered so as to maintain a fixed working distance W.D. with respect to the heating device 42.

In one embodiment, the radial laminar flow localized protective atmosphere device 30 is secured to an external holder (not shown), and the respective positioning with respect to either or both of the tip and/or shoulder of rod 12 is sensed and controlled (the sensors and controllers are not shown).

In another embodiment, the radial laminar flow localized protective atmosphere device 30 is moved by a moving device (not shown) to slide up and down as needed so as to maintain the desired position with respect to either or both of the tip and/or shoulder of rod 12 (the respective sensors and controllers are not shown).

Reverting back to FIGS. 5A-5B: the laminar flow localized protective atmosphere devices 50, 52, according to embodiments of the invention, are designed to provide localized protective atmosphere shielding for the metal source (rod 12 of FIG. 1) by covering its tip, shoulder, and middle areas—as well as other areas such as areas within the space heated by the heating device 42 of FIG. 4. FIGS. 5A-5B illustrate various arrangements of the output gas channels. In FIG. 5A, some of the output gas channels are straight—channels 318, and some are radially inclined (differ in their azimuthal angle)—channels 319. In FIG. 5B, all of the output channels 319 are radially inclined (differ in their azimuthal angle).

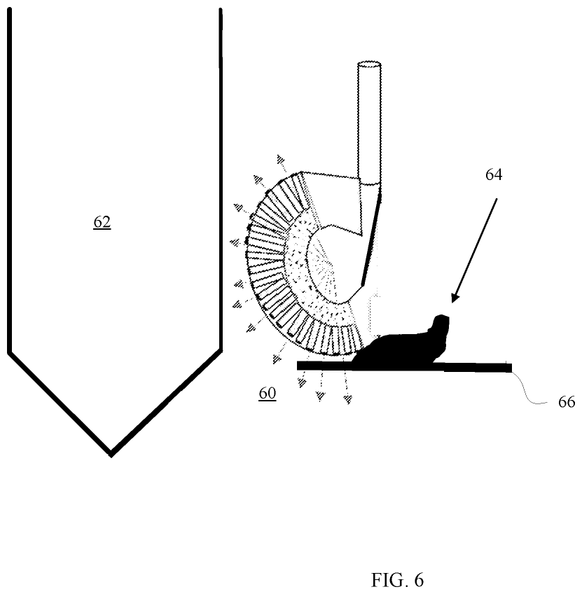

FIG. 6 illustrates a laminar flow localized protective atmosphere device 60 that aims to cover the tip, shoulder and middle part of rod 62, as well as the drop area defined by the upper surface of heating device 66 and the landing area (not shown). In the embodiment shown in FIG. 6, the laminar flow localized protective atmosphere device 60 is connected to the heating device 66 via support 64.

In certain additive casting scenarios, additional shielding may be needed. For example, the passageway of molten metal drops dripping from the heated tip of rod 12 (denoted as drop area) and part of all of the drop landing area (denoted as landing area). In some additive casting scenarios, previously deposited metal at the landing area is heated before additional metal drops are added. In some additive casting scenarios, a melt pool is generated at the landing area to receive the currently dripping metal drops.

In some embodiments of the invention, the gas distribution array aiming at the drop area and the landing area is integrated with one or more gas distribution arrays aiming at the tip, shoulder, and middle areas of the rod. In other embodiments, the drop area and landing area are covered by one or more dedicated gas distribution arrays. In some embodiments, the rod tip area, drop area, and, optionally, the landing area are covered by a dedicated gas distribution array.

In some embodiments employing more than a single gas distribution array, part of the gas distribution arrays may be realized as straight gas channels (honeycomb).

In some embodiments, only a part of the gas channels is radially inclined toward the metal source.

In some embodiments, the laminar flow localized protective atmosphere device may further comprise a radial setting chamber located downstream of the radial gas distribution array, optionally followed by a mesh, to thereby adding additional uniformity to the gas distribution.

FIG. 7 is a cross sectional view of an example of a protective device 90 that illustrates inlet 317-1 that is followed by the first distribution chamber 317-2 that is followed by a second distribution chamber 317-3 that is coupled to the first distribution chamber 317-2 by a barrier channel 344. The second distribution chamber 317-3 is followed by gas outlet channels 314. The input of the barrier channel is lower than the output of the barrier channel (bottom-up orientation).

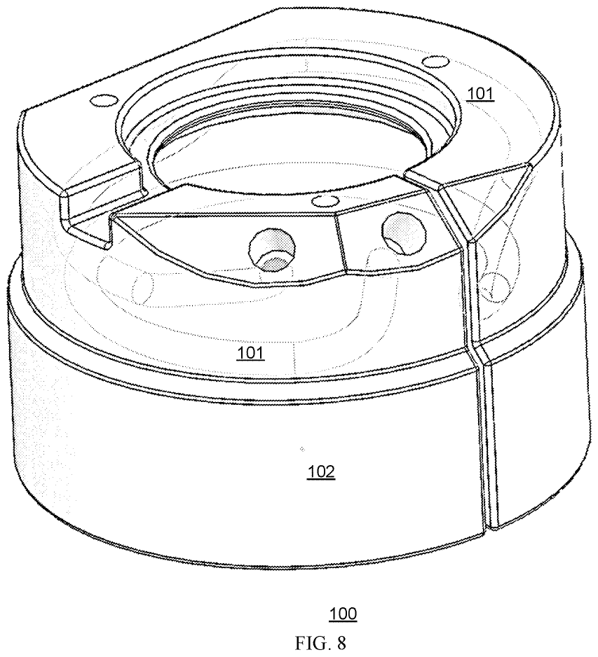

FIGS. 8-10 illustrate different views of an example of a protective device 100.

The protective device 100 includes housing 102, a liquid cooling element 101 located within the housing, and main inlet 111 that receives the inlet gas and splits it between distribution conduits 112 that are followed by one or more first distribution chamber 113. The one or more first distribution chamber 113 are followed by barrier channels 114 that are followed by one or more second distribution chambers 115. The one or more second distribution chambers 115 are followed by gas output channels 116 for outputting the inert gas.

Embodiments of the invention are designed to be used within an additive casting system. Depending on the selection of materials, in some embodiments, cooling of part or all of the elements of the protective device is required, for example, to enable thin walls of housing made of Inconel or Aluminium. In other embodiments, for example, using ceramic housing, no cooling is needed.

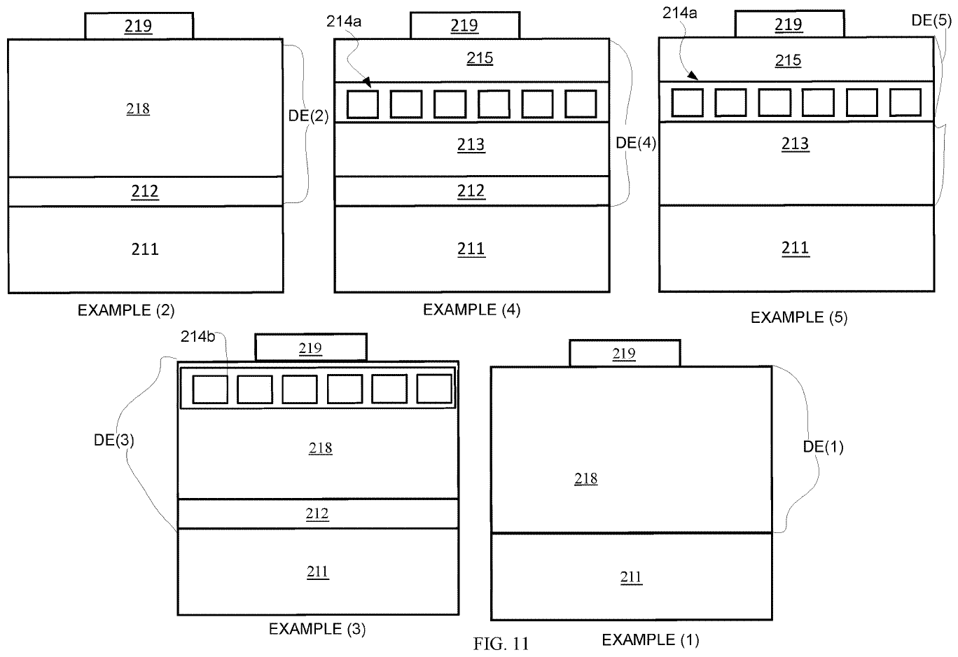

FIGS. 11-12 are schematic illustrations of examples of protective devices, depicting the structural and functional relationship of the various components of the protective device. The geometrical aspects and specific design of the various examples discussed in previous Figures are not depicted in FIGS. 11-12.

Each of the examples shown in FIGS. 11-12 includes a distribution inlet 219 and gas output channels 211, part or all of which are radially inclined. As discussed with reference to FIG. 3D, gas output channels 211 output inert gas in a plurality of directions, wherein the multiple directions differ from each other by an azimuthal angle, while maintaining a laminar flow at least in proximity to the protective device. Gas output channels 211 may output inert gas in a plurality of directions, wherein the multiple directions differ from each other by a polar angle.

The example configurations (1)-(5) illustrated in FIG. 12 differ by the configuration of the respective distribution elements DE(1)-DE(5).

Example (1) Distribution inlet 219—distribution element such as distribution chamber 218—gas output channels 211. The distribution element DE(1) is configured as one or more distribution chambers (a single distribution chamber 218 is shown in FIGS. 12-13 for simplicity of explanation).

Example (2): Distribution inlet 219—distribution chamber 218—porous material elements 212—gas output channels 211. The distribution element DE(2) allows restricting the flow of the incoming inert gas by the combined effect of the distribution of the inert gas in distribution chamber 218 and its passage to the outlet channels through porous material elements 212. This example is discussed above with reference to FIGS. 5A-5B.

Example (3): Distribution inlet 219—barrier channel 214b—distribution chamber 218—porous material elements 212—gas output channels 211. This example was discussed with reference to FIGS. 3A-3D. Barrier channel 214b may have a top-down orientation the barrier channel input is higher than the barrier channel output. The invention is not limited by the number of barrier channels, such as barrier channel 214b. Compared to configuration example (2), the addition of the barrier channels 214b enables the use of a thin porous material layer. Further, a desired laminar flow zone is received closer to the protective device and can be achieved without a setting chamber and metal mesh that are offered by prior art systems downstream of the output channels.

Example (4): Distribution inlet 219—first distribution chamber 215—barrier channel 214a—second distribution chamber 213—porous material elements 212—gas output channels 211. Compared to configuration example (2), the flow of the inert gas is further restricted by directing the inert gas between one or more barrier channels 214a located between the first distribution chamber 215 and the second distribution chamber 213. Barrier channels 214a may have a bottom-up design (the input of barrier channels 214a is lower than that output of barrier channels 214a.), thereby increasing the resistivity of the barrier channels. Six such bottom-up barrier channels 214a are schematically illustrated; however, the invention is not limited by the number of barrier channels 214a.

Example (5): Distribution inlet 219—first distribution chamber 215—barrier channel 214a—second distribution chamber 213—gas output channels 211. Compared to configuration example (4), no porous material elements 212 are used, and the flow of the inert gas is restricted by directing the inert gas between one or more barrier channels 214a. Six such bottom-up barrier channels 214a are schematically illustrated; however, the invention is not limited by the number of barrier channels 214a.

Examples (4) and (5) may also obviate the use of a setting chamber and metal mesh that are offered by prior art systems downstream of the gas channels.

Any distribution inlet 219 may include a primary distribution inlet 219-1 that is followed by a distributor 219-2 that is followed by secondary inlets 219-3. This is illustrated in FIG. 12.

The example configurations (6) and (7) illustrated in FIG. 12 differ from example configurations (1)-(5) illustrated in FIG. 11 by the configuration of distribution 219. Distribution inlet 219 is composed of primary distribution inlet 219-1—distributor 219-2 (e.g., a gas splitter)—secondary inlets 219-3. Three secondary inlets 219-3 are shown; however, the invention is not limited by the number of secondary inlets.

The primary distribution inlet 219-1—distributor 219-2—secondary inlets 219-3 configuration may be used with any of the distribution element configurations DE(1)-(5) shown in FIG. 11. Two such examples are shown in FIG. 11 for illustration: example (6) shows the combination of the primary distribution inlet 219-1—distributor 219-2—secondary inlets 219-3 with distribution element DE(4). Example (7) shows the combination of the primary distribution inlet 219-1—distributor 219-2—secondary inlets 219-3 with distribution element DE(5).

For simplicity of explanation, FIGS. 11-12 show a protective device having a single inlet and a single distribution element to evenly distribute the inert gas between multiple gas channels. However, various embodiments of the invention may include one or more inlets and one or more distribution elements. The one or more inlets may or may not be identical in their configuration. The one or more distribution elements may or may not be identical in their configuration. Thus, a protective device having two or more distribution elements may be composed as a combination of distribution element configurations.

For ease of explanation, the various arrangements of the output gas channels are illustrated with reference to FIGS. 5A-5B; however, the various arrangements of the output gas channels may be implemented with any of the inlet configurations and distribution elements discussed herein.

FIG. 13 is a simulation example of flow of inert gas and Oxygen concentration within an additive casting chamber 45. The inert gas stream lines and Oxygen concentration levels are shown within the vicinity of rod 40, the protective device 30, the heating device 42 for heating the rod, and the surface heating device (surface heater) 44. In operation, additive casting chamber 45 is traveling over a work surface 46; heating device 42 heats rod 40 up to melting its tip—in response, metal drops fall from rod 40 onto the work surface (not shown) before, during, or after molten metal dripping, surface heater 44 heats the work surface (not shown).

Laminar flow in the vicinity of the protective device is required to ensure high, continuous shielding. In the presence of turbulences, the inert environment may be decreased due to low-pressure areas that carry Oxygen from the outside.

FIG. 13 depicts inert gas stream lines SL and shows that the protected environment in the proximity of protection device 30 reflects laminar flow of the inert gas. A few backflows are introduced within additive casting chamber 45 (see, for example, first backflow 71, second backflow 72, and third backflow 73). The concentration of Oxygen within additive casting chamber 45 is substantially unified and considerably lower compared to the concentration of Oxygen outside of additive casting chamber 45. Oxygen concentration level 1 within additive casting chamber 45 is in the order of 100 ppm, while Oxygen concentration level 2 is in the order of 2×105 ppm. The simulation example illustrated in FIG. 13 shows that achieving a laminar flow of inert gas in the vicinity of the radially inclined protective device facilitates high, continuous shielding within the additive casting chamber 45—including in the tip area and rod shoulder area that are concealed from the protective device.

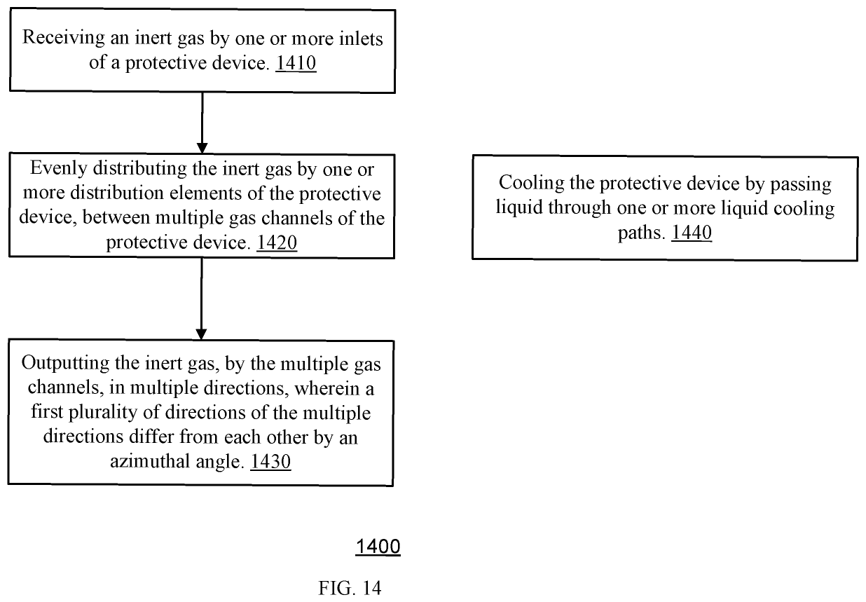

FIG. 14 illustrates at example of method 1400 od for protecting a metal source.

Method 1400 may be executed by any of the protective devices illustrated in any of the previous Figures.

Method 1400 includes a sequence of steps 1410, 1420 and 1430.
i. Step 1410 of receiving an inert gas by one or more inlets of a protective device.
ii. Step 1420 of evenly distributing the inert gas by one or more distribution elements of the protective device, between multiple gas channels of the protective device.
iii. Step 1430 of outputting the inert gas, by the multiple gas channels, in multiple directions, wherein a first plurality of directions of the multiple directions differ from each other by an azimuthal angle.

Method 1400 may include maintaining a laminar flow at least in proximity to the protective device during the outputting of the inert gas.

Method 1400 may also include step 1440 of cooling the protective device by passing the liquid through one or more liquid cooling paths. Step 1440 may be executed in parallel to at least one of steps 1410, 1420, and 1430.

According to an embodiment, there is provided a protective device for protecting a metal source, the protective device includes (i) one or more diffusion chambers having each one or more gas inlets for receiving an inert gas, (ii) one or more ceramic foam layer located downstream of the one or more diffusion chamber, (iii) one or more radial gas distribution arrays located and downstream of the ceramic foam layer, (iv) wherein the radial gas distribution array comprises a plurality of gas channels which are radially inclined with respect to the metal source.

According to an embodiment, the metal source is one of a group consisting of a metal rod, a metal wire, and a welding torch.

According to an embodiment, the device includes a setting chamber located downstream of the radial gas distribution array.

According to an embodiment, the device includes a mesh located downstream of the setting chamber.

According to an embodiment, the ceramic foam layer is made with 10, 20, 30, 40, 50, 60, 70, 80 pores per inch (PPI).

According to an embodiment, the ceramic foam layer is made of a refractory ceramic material.

According to an embodiment, the plurality of gas channels, each having a selected cross-section shape, a length Li and a diameter Di, and wherein for each gas channel, the length L is equal or larger than five times the respective diameter Di: Li>=5×Di.

According to an embodiment, the radial gas distribution array comprises a plurality of gas channels having non-identical lengths.

According to an embodiment, the radial gas distribution array comprises a plurality of gas channels having non-identic across-section shapes.

According to an embodiment, the radial gas distribution array comprises a plurality of gas channels having non-identical diameters.

According to an embodiment, the device has a closed-loop shape enveloping the metal source.

According to an embodiment, the closed-loop shape has a circular shape or a polyhedron shape.

The laminar flow localized protective atmosphere device was described mainly with reference to shielding a metal rod that is used as a metal source in systems for digitally planned and controlled additive metal casting. However, the invention is not limited to such a metal source and is applicable to any other metal source. For example, a metal wire, a welding torch, and the like. Further, the invention may be applicable to other manufacturing techniques, for example, three-dimensional printing, using a variety of materials.

Distribution element configurations DE(4)-(7) illustrated in FIGS. 11 and 12, and the specific design example illustrated in FIG. 7, were presented in the context of radially inclined output gas channels. It should be noted that the distribution element configurations DE(4)-(7) and the specific design example illustrated in FIG. 7 are equally applicable to straight output gas channels. The combination of distribution element configurations DE(4)-(7) and the specific design example illustrated in FIG. 7 with straight output gas channels will allow (1) the use of a thinner porous material layer compared to prior art systems; (2) enable no use of porous material layer and (3) obviates the need for a setting chamber and metal mesh as offered by prior art systems.

As used throughout the specification, the terms “metal” or “metallic” refers to any metals and/or metallic alloys which are suitable for melting and depositing, for example, ferrous alloys, aluminum alloys, copper alloys, nickel alloys, magnesium alloys, and the like. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “inner”, “outer”, “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

However, other modifications, variations, and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A protective device for protecting a metal source, the protective device comprises:
multiple gas channels;
one or more inlets configured to receive an inert gas; and
one or more distribution elements configured to receive the inert gas from the one or more inlets and to evenly distribute the inert gas between the multiple gas channels;
wherein the multiple gas channels are configured to output the inert gas in multiple directions, wherein a first plurality of directions of the multiple directions differ from each other by an azimuthal angle.

2. The protective device according to claim 1, wherein the multiple gas channels are configured to output the inert gas at the multiple directions while maintaining a laminar flow at least in proximity to the protective device.

3. The protective device according to claim 1, wherein the one or more distribution elements comprise one or more distribution chambers for restricting airflow of the inert gas between the one or more inlets and the multiple gas channels.

4. The protective device according to claim 3, wherein the one or more distribution elements further comprise one or more barrier channels for fluidly coupling the one or more inlets to the one or more distribution chambers.

5-8. (canceled)

9. The protective device according to claim 4, wherein a barrier channel of the one or more barrier channels has a barrier channel input that is (i) higher than a barrier channel output or (ii) lower than a barrier channel output.

10. (canceled)

11. The protective device according to claim 1, wherein the one or more distribution elements comprise one or more first distribution chambers and one or more second distribution chambers, the one or more second distribution chambers are downstream of the one or more first distribution chambers and further comprising one or more barrier channels for fluidly coupling the one or more first distribution chambers to the one or more second distribution chambers.

12. (canceled)

13. The protective device according to claim 1, wherein the multiple gas channels are (1) formed in a bulk or (2) are spaced apart pipes having gaps therebetween.

14. (canceled)

15. The protective device according to claim 1, wherein at least one of (i) a second plurality of directions of the multiple directions differs from each other by a polar angle; (ii) a third plurality of directions of the multiple directions share a same azimuthal angle and (iii) a fourth plurality of directions of the multiple directions share a same polar angle.

16-17. (canceled)

18. The protective device according to claim 1, comprising one or more liquid cooling paths.

19-20. (canceled)

21. The protective device according to claim 1, wherein the metal source is a rod and wherein at least one of (i) a shoulder area of the rod and (ii) a tip of the rod is concealed from at least one of the multiple gas channels.

22. (canceled)

23. A method for protecting a metal source, the method comprises:
receiving an inert gas by one or more inlets of a protective device;
evenly distributing the inert gas by one or more distribution elements of the protective device, between multiple gas channels of the protective device; and
outputting the inert gas, by the multiple gas channels, in multiple directions, wherein a first plurality of directions of the multiple directions differ from each other by an azimuthal angle.

24. The method according to claim 23, comprising maintaining a laminar flow at least in proximity to the protective device during the outputting of the inert gas.

25. The method according to claim 23, wherein the one or more distribution elements comprise one or more distribution chambers for restricting airflow of the inert gas between the one or more inlets and the multiple gas channels.

26. The method according to claim 25, wherein the one or more distribution elements further comprise one or more barrier channels for fluidly coupling the one or more inlets to the one or more distribution chambers.

27.-30. (canceled)

31. The method according to claim 26, wherein a barrier channel of the one or more barrier channels has a barrier channel input that is (i) higher than a barrier channel output or (ii) lower than a barrier channel output.

32. (canceled)

33. The method according to claim 23, wherein the one or more distribution elements comprise one or more first distribution chambers and one or more second distribution chambers, the one or more second distribution chambers are downstream of the one or more first distribution chambers, the protective device further comprising one or more barrier channels for fluidly coupling the one or more first distribution chambers to the one or more second distribution chambers.

34-36. (canceled)

37. The method according to claim 23, wherein at least one of (i) a second plurality of directions of the multiple directions differ from each other by a polar angle, (ii) a third plurality of directions of the multiple directions share a same azimuthal angle, and (iii) a fourth plurality of directions of the multiple directions share a same polar angle.

38-39. (canceled)

40. The method according to claim 23, comprising cooling the protective device by passing liquid through one or more liquid cooling paths.

41-42. (canceled)

43. The method according to claim 23, wherein the metal source is a rod and wherein at least one of (i) a shoulder area of the rod and (ii) a tip of the rod is concealed from at least one of the multiple gas channels.

44. (canceled)
